(19) United States
(12) Patent Application Publication
(10) Pub. No.: US 2019/0335265 A1
(43) Pub. Date: Oct. 31, 2019

(54) WIRELESS EARPHONE CHARGING CRADLE AND SYSTEM THEREOF

(71) Applicant: Tymphany Acoustic Technology (Huizhou) Co., Ltd., Huizhou City (CN)

(72) Inventor: Chia-Hsin HUNG, Huizhou City (CN)

(21) Appl. No.: 16/395,023

(22) Filed: Apr. 25, 2019

(30) Foreign Application Priority Data
Apr. 28, 2018 (CN) 201810397979.9

(51) Int. Cl. H04R 1/10; H02J 7/00; H01R 24/58

(52) U.S. Cl. CPC H04R 1/1025; H01R 24/58; H02J 7/0044; H02J 7/0068

(57) ABSTRACT

A wireless earphone charging cradle includes a charging module, an audio output interface, and a microprocessor. After being electrically connected to a wireless earphone, the charging module charges the wireless earphone. The audio output interface generates and sends a sensing signal after being triggered. The microprocessor is electrically connected to the charging module, after receiving the sensing signal, the microprocessor generates a connection signal and transmits the connection signal to the wireless earphone by using the charging module, so that the wireless earphone is electrically connected to the audio output interface, and an audio signal received by the wireless transceiver of the wireless earphone is transmitted to the audio output interface for output. Therefore, an antenna does not need to be set based on a wireless transmission function of the wireless earphone, to save costs and simplify design, and to provide audio source output while charging the wireless earphone.

### CROSS REFERENCE TO RELATED APPLICATIONS

This application claims priority of Application No. CN 201810397979.9 filed in China on Apr. 28, 2018 under 35 U.S.C. § 119, the entire contents of all of which are hereby incorporated by reference.

### BACKGROUND

### Technical Field

The present invention relates to the field of charging devices, and in particular, to a wireless earphone charging cradle.

### Related Art

With the development of smartphones in recent years, mobile phones have become main interfaces of multimedia such as music, films, and games. With the development of wireless technologies and simplification of mobile phone structures, a ratio of using wireless earphones, such as Bluetooth earphones, has also gradually increased.

However, because a wireless earphone, in particular an in-ear wireless earphone or an earbud, has a relatively small volume/size, it is almost impossible to put a battery with large electricity into the earphone. Thus, the use of the earphone would not be long. Accordingly, the wireless earphone is usually provided with a charging case or charging cradle, to charge the wireless earphone at any time.

However, the wireless earphone cannot be used when being charged in the charging case.

### SUMMARY

A wireless earphone charging cradle is provided in this disclosure. The wireless earphone charging cradle includes a charging module, an audio output interface, and a microprocessor.

When the wireless earphone is connected with the charging module, the wireless earphone is charged. The audio output interface generates and sends a sensing signal after being triggered. The microprocessor is electrically connected to the charging module and the audio output interface respectively, the microprocessor generates a connection signal after receiving the sensing signal and transmits the connection signal to the wireless earphone by using the charging module, so that the wireless earphone is electrically connected to the audio output interface, and an audio signal received by the wireless transceiver of the wireless earphone is transmitted to the audio output interface for output.

In some embodiments, the charging module includes a first electric connector. The first electric connector is electrically connected to the audio output interface, and when the charging module is electrically connected to the wireless earphone, the first electric connector is electrically connected to a second electric connector, so that the charging module charges the wireless earphone.

Further, in some embodiments, the wireless earphone further includes a third electric connector. The third electric connector is electrically connected to an electroacoustic transducer of the wireless earphone. After the microprocessor generates the connection signal and sends the connection signal to the wireless earphone, the wireless earphone disconnects the electric connection between the third electric connector and the electroacoustic transducer. The third electric connector is electrically connected to the second electric connector, and the audio output interface outputs the audio signal received by the wireless transceiver of the wireless earphone.

In some embodiments, the charging module further includes a battery and a charging circuit, and after the first electric connector is electrically connected to the second electric connector, the battery charges the wireless earphone by using the charging circuit, the first electric connector, and the second electric connector. Further, in some embodiments, the charging module further includes a transformer and a second charging circuit. The second charging circuit is connected to the transformer, after the transformer is connected to a power supply, the microprocessor causes the transformer to be electrically connected to the charging circuit, and the battery is connected to the second charging circuit. An electric power is provided by the power supply and transformed by the transformer for charging the wireless earphone by way of the charging circuit, the first electric connector, and the second electric connector, and the battery is charged by way of the second charging circuit.

In some embodiments, the wireless earphone charging cradle further includes an amplifier. The amplifier is electrically connected to the audio output interface. When the microprocessor generates the connection signal and sends the connection signal to the wireless earphone, the audio signal received by the wireless transceiver is amplified and is output by the audio output interface.

In some embodiments, the audio output interface is a 3.5 mm audio port, a USB port, a mini USB port, a micro USB port, or a lightning port. Further, in some embodiments, the audio output interface is triggered by being inserted by an audio playing apparatus, after the wireless earphone is electrically connected to the audio output interface, the audio signal received by the wireless transceiver is output to the audio playing apparatus for playing.

In some embodiments, the audio output interface includes a trigger input device and a speaker. The audio output interface is triggered by pressing the trigger input device, and the trigger input device is electrically connected to the microprocessor. When being pressed, the trigger input device generates the sensing signal and sends the sensing signal to the microprocessor, the microprocessor causes the wireless earphone to be electrically connected to the speaker, and the audio signal received by the wireless transceiver is output to the speaker for playing.

In some embodiments, the wireless earphone charging cradle further includes a pulse modulation unit. The pulse modulation unit is electrically connected to the microprocessor and modulates the connection signal sent by the microprocessor in a pulse waveform.

In some embodiments, when the charging module is electrically connected to the wireless earphone, the wireless earphone generates an electricity signal to the microprocessor, the microprocessor determines, according to the electricity signal, whether charging of the wireless earphone is completed, and when determining that charging of the wireless earphone is completed, the microprocessor sends a stopping signal to the charging module and stops charging the wireless earphone.

The wireless earphone charging cradle can apply a wireless receiving and transmitting function of the wireless earphone, and an antenna or another wireless receiving and transmitting component(s) does not need to be additionally set at the charging cradle, to save costs and simplify design, and to achieve an effect of providing audio source output while charging the wireless earphone.

### BRIEF DESCRIPTION OF THE DRAWINGS

The present invention will become more fully understood from the detailed description given herein below for illustration only, and thus are not limitative of the present invention, and wherein:

FIG. 1 is a schematic block diagram of an embodiment of a wireless earphone charging system;

FIG. 2 and FIG. 3 are respectively schematic block diagrams of an embodiment of a wireless earphone charging system before and after triggering;

FIG. 4 and FIG. 5 are respectively schematic block diagrams of an embodiment of a charging module of a wireless earphone charging cradle;

FIG. 6 is a schematic diagram of an appearance of an embodiment of an audio output interface of a wireless earphone charging cradle; and

FIG. 7 is a schematic diagram of an appearance of another embodiment of an audio output interface of a wireless earphone charging cradle.

### DETAILED DESCRIPTION

Preferred implementations of the present invention are described below with reference to the accompanying drawings. A person of ordinary skill in the art should understand that these implementations are merely used to explain the technical principle of the present invention and are not intended to limit the protection scope of the present invention.

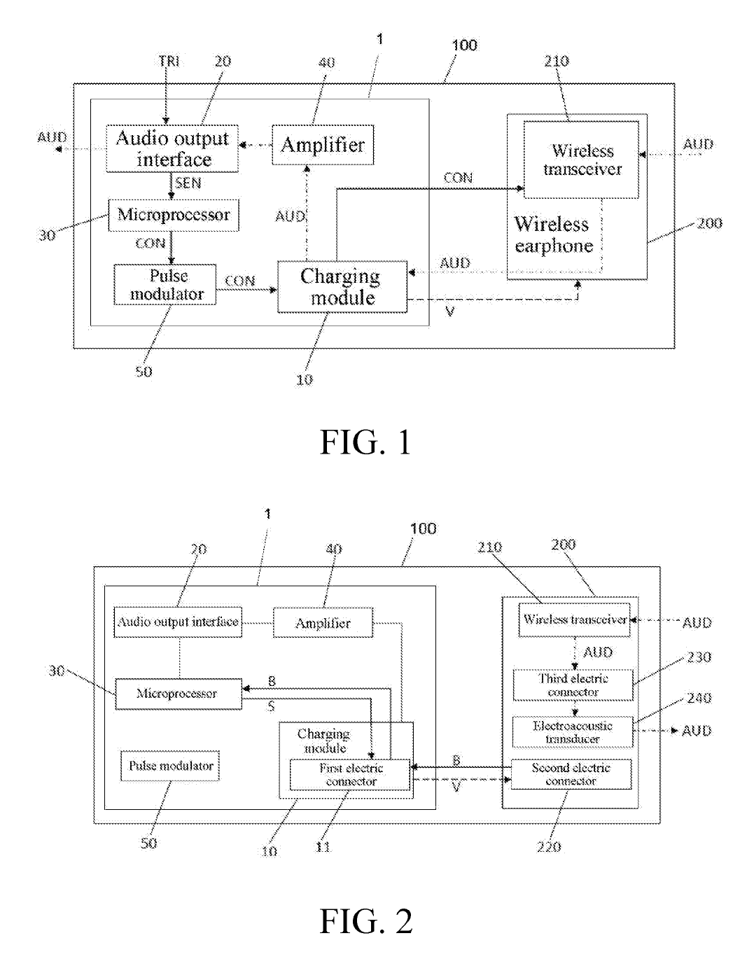

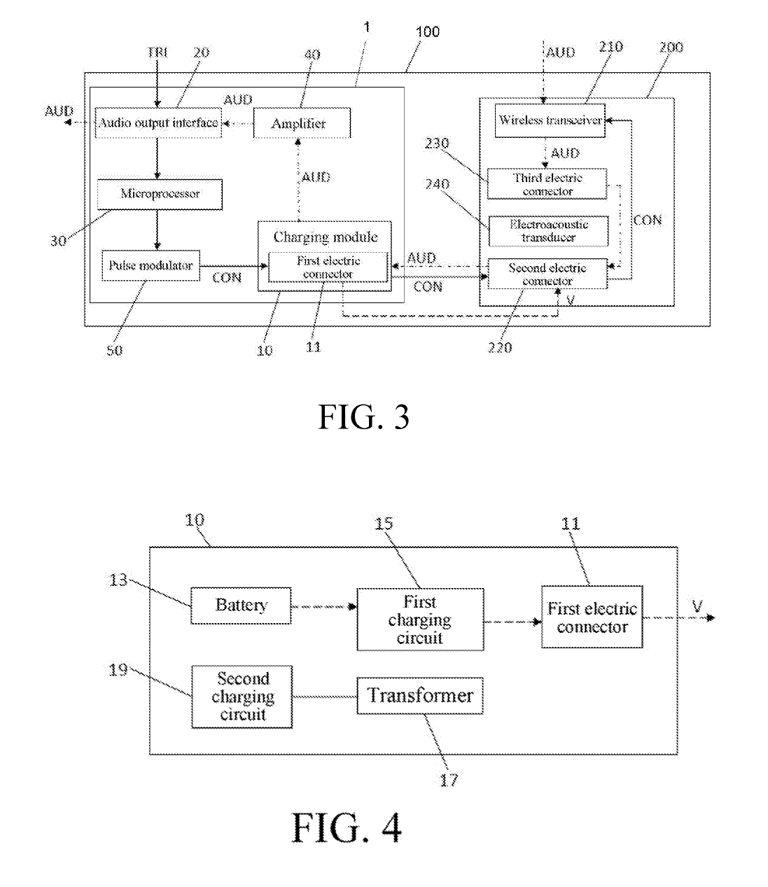

FIG. 1 is a schematic block diagram of an embodiment of a wireless earphone charging system 100. The system 100 includes a wireless earphone charging cradle 1 and a wireless earphone 200. FIG. 2 and FIG. 3 are respectively schematic block diagrams of an embodiment of a wireless earphone charging cradle before and after triggering. As shown in FIG. 1, a wireless earphone charging cradle 1 includes a charging module 10, an audio output interface 20, and a microprocessor 30. The wireless earphone charging cradle 1 is used to charge a wireless earphone 200.

When the wireless earphone charging cradle 1 is connected to the wireless earphone 200, the charging module 10 charges the wireless earphone 200, for example, the charging module 10 outputs a voltage V to the wireless earphone 200 for charging. After receiving a triggered signal TRI, the audio output interface 20 generates a sensing signal SEN and sends the sensing signal SEN to the microprocessor 30. For example, the audio output interface 20 may be a 3.5 mm audio port. The triggered signal TRI may be generated by the insertion of an audio plug. The microprocessor 30 is electrically connected to the charging module 10 and the audio output interface 20. After receiving the sensing signal SEN, the microprocessor 30 generates a connection signal CON and transmits the connection signal CON to the wireless earphone 200 by using the charging module 10, so that an audio signal AUD received by a wireless transceiver 210 of the wireless earphone 200 is transmitted to the audio output interface 20 for output. Further detailed descriptions are provided below.

The electrical connection described in this disclosure may be a direct connection or indirect connection via a third component. In addition, the wireless transceiver 210 of the wireless earphone 200 may be a Bluetooth transceiver, a WiFi transceiver, a Zigbee transceiver, or the like. However, the foregoing transceivers are merely used for example, and the wireless transceiver 210 is not limited thereto. In this embodiment, the wireless earphone charging cradle 1 may receive and transmit the audio signal AUD by using the wireless transceiver 210 of the wireless earphone 200. There is no need to add a circuit and a component for receiving and transmitting the audio signal, and the audio signal AUD may be continuously received and transmitted when the wireless earphone 200 is charged.

FIG. 2 is a schematic block diagram of an embodiment of a wireless earphone charging cradle before triggering. The wireless earphone charging cradle 1 is connected to the wireless earphone 200 but not triggered for the triggering signal TM. That is, in this state, the wireless earphone charging cradle 1 charges only the wireless earphone 200. The charging module 10 includes a first electric connector 11. The first electric connector 11 is electrically connected to the audio output interface 20. When the charging module 10 is electrically connected to the wireless earphone 200, the first electric connector 11 is electrically connected to a second electric connector 220 of the wireless earphone 200, so that the charging module 10 charges the wireless earphone 200. For example, the charging module 10 outputs a voltage V to the wireless earphone 200 for charging. Herein, the first electric connector 11 and the second electric connector 220 include corresponding contact terminals and/or contact pads and may be electrically connected for charging when mutually contacting.

It should be noted that as shown in FIG. 2, the wireless earphone 200 further includes a third electric connector 230 and an electroacoustic transducer 240. The third electric connector 230 is electrically connected to the electroacoustic transducer 240. In a general state in which the signal TRI is not triggered, if the wireless transceiver 210 of the wireless earphone 200 receives the audio signal AUD, by using the third electric connector 230, the wireless transceiver 210 transmits the audio signal AUD to the electroacoustic transducer 240 for playing.

FIG. 3 is a schematic block diagrams of an embodiment of a wireless earphone charging cradle after triggering. The wireless earphone charging cradle 1 is connected to the wireless earphone 200, and the signal TRI is triggered. The wireless earphone charging cradle 1 charges the wireless earphone 200 and also receives and transmits the audio signal AUD by using the wireless transceiver 210. The audio output interface 20 generates a sensing signal SEN and sends the sensing signal SEN to the microprocessor 30. After receiving the sensing signal SEN, the microprocessor 30 generates a connection signal CON and transmits the connection signal CON to the wireless earphone 200 by using the first electric connector 11. In this state, the wireless earphone 200 disconnects the electric connection between the third electric connector 230 and the electroacoustic transducer 240, and the third electric connector 230 is electrically connected to the second electric connector 220. The audio signal AUD received by the wireless transceiver 210 of the wireless earphone 200 may be output from the audio output interface 20 by way of the third electric connector 230, the second electric connector 220, and the first electric connector 11. Herein, the first electric connector 11, the second electric connector 220, and/or the third electric connector 230 further include variable switches, different input and output channels, or channels of electric signals deployed according to actual conditions. In one embodiment, the first electric connector 11, the second electric connector 220, and/or the third electric connector 230 are switches.

Referring to FIG. 1 to FIG. 3 again, the wireless earphone charging cradle 1 further includes an amplifier 40. The amplifier 40 is electrically connected to the audio output interface 20. When the microprocessor 30 generates the connection signal CON and transmits the connection signal CON to the wireless earphone 200, the amplifier 40 is electrically connected to the wireless earphone 200, so that the audio output interface 20 is electrically connected to the wireless earphone 200. The amplifier 40 amplifies the audio signal AUD received by the wireless transceiver 210, and the audio output interface 20 outputs the amplified audio signal AUD.

In more detail, the audio signal AUD received by the wireless transceiver 210 and amplified by the amplifier 40 is output from the audio output interface 20 by way of the third electric connector 230, the second electric connector 220, the first electric connector 11, and the amplifier 40. Herein, when the audio output interface 20 is connected to a wired earphone and the wireless earphone charging cradle 1 charges the wireless earphone 200, the wired earphone may be used as an earphone speaker. In this way, a frequency response of the wired earphone in a particular frequency band, such as a low frequency band, can be provided, so that finer sound quality is provided.

Referring to FIG. 1 to FIG. 3 again, the wireless earphone charging cradle 1 further includes a pulse modulator 50. The pulse modulator 50 is electrically connected to the microprocessor 30 and modulates the connection signal CON sent by the microprocessor 30 in a pulse waveform.

Referring to FIG. 2 again, when the charging module 10 is electrically connected to the wireless earphone 200 for charging, the wireless earphone 200 further generates an electricity signal B to the microprocessor 30. According to the electricity signal B, the microprocessor 30 determines whether charging of the wireless earphone 200 is completed. When the charging of the wireless earphone 200 is completed, the microprocessor 30 sends a stopping signal S to the charging module 10 and stops charging the wireless earphone 200, that is, stops outputting the voltage V to the wireless earphone 200. In this way, overcharging can be further prevented, and it avoids causing damage to a battery of the wireless earphone 200.

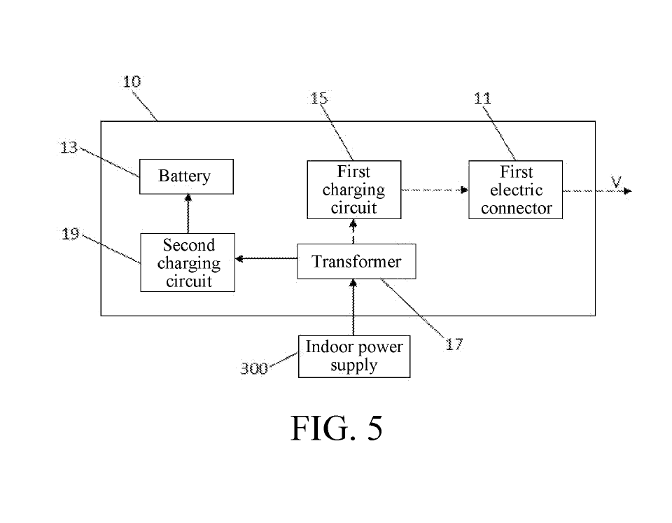

FIG. 4 and FIG. 5 are respectively schematic block diagrams of an embodiment of a charging module of a wireless earphone charging cradle. As shown in FIG. 4, the charging module 10 includes a battery 13 and a charging circuit (a first charging circuit) 15. When the first electric connector 11 is electrically connected to the second electric connector 210, the battery 13 charges the wireless earphone 200 by way of the first charging circuit 15, the first electric connector 11, and the second electric connector 210.

As shown in FIG. 5, the charging module 10 further includes a transformer 17 and a second charging circuit 19, and the second charging circuit 19 is connected to the transformer 17. When the transformer 17 is connected with a power supply 300 (e.g., an indoor power supply), the microprocessor 30 can cause the transformer 17 to be electrically connected to the charging circuit 15. The battery 13 is connected to the second charging circuit 19. The electric power may be provided by the power supply 300 and transformed by the transformer 17, so as to charge the wireless earphone 200 by way of the first charging circuit 15, the first electric connector 11, and to charge the battery 13 by way of the second charging circuit 19. Herein, the first charging circuit 15 and the second charging circuit 19 may include variable switches, a plurality of input and output channels, or channels of electric signals deployed according to actual conditions. In this way, the wireless earphone charging cradle 1 can be placed indoor for use or may be conveniently and portably used, which is not limited to the description.

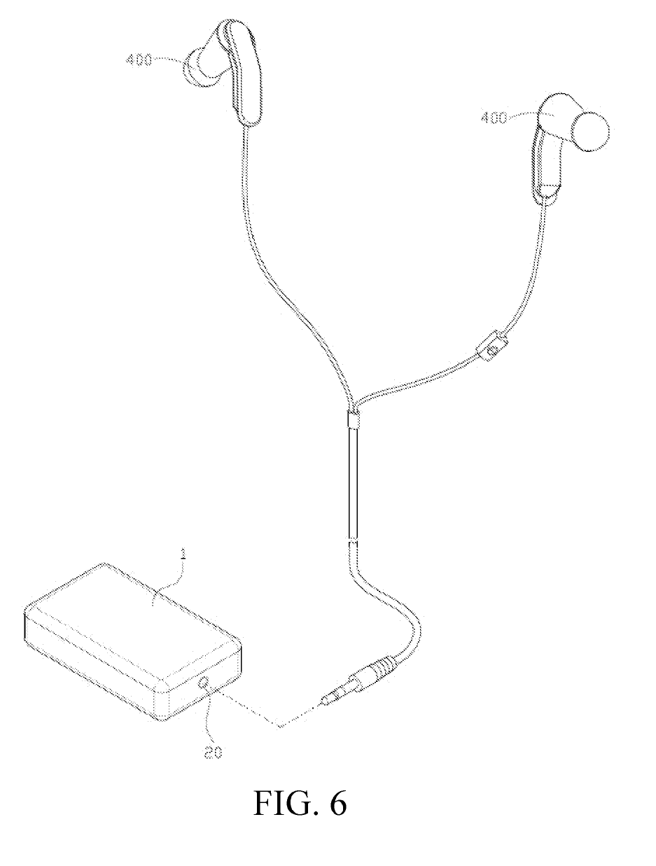

FIG. 6 is a schematic stereoscopic diagram of an embodiment of an audio output interface of a wireless earphone charging cradle. As shown in FIG. 6, the audio output interface 20 of the wireless earphone charging cradle 1 is an audio port for an audio line plug. The audio output interface 20 is shown in a shape of a common 3.5 mm audio port, but which is not limited thereto. The audio output interface 20 may be a 3.5 mm audio port, a USB port, a mini USB port, a micro USB port, a lightning port, or the like. The audio output interface 20 may be connected with an audio playing apparatus 400 having a corresponding plug end. Although the audio playing apparatus 400 shown in the figure is the wired earphone, the audio playing apparatus 400 may also be any other speaker(s) having a corresponding plug, or the like. In addition, as described in FIG. 1 and FIG. 3, the audio output interface 20 generates the triggering signal TRI by detecting an insertion of the audio playing apparatus 400. After the wireless earphone 200 is electrically connected to the audio output interface 20, the audio signal AUD received by the wireless transceiver 210 can be output to the audio playing apparatus 400 through the audio output interface 20 for playing. In this way, when a user is doing exercise or hopes to continuously listen to music, although the wireless earphone 200 needs to be charged, the wireless earphone charging cradle 1 can still provide an audio source, and the user may continue to listen to music by using the audio playing apparatus 400.

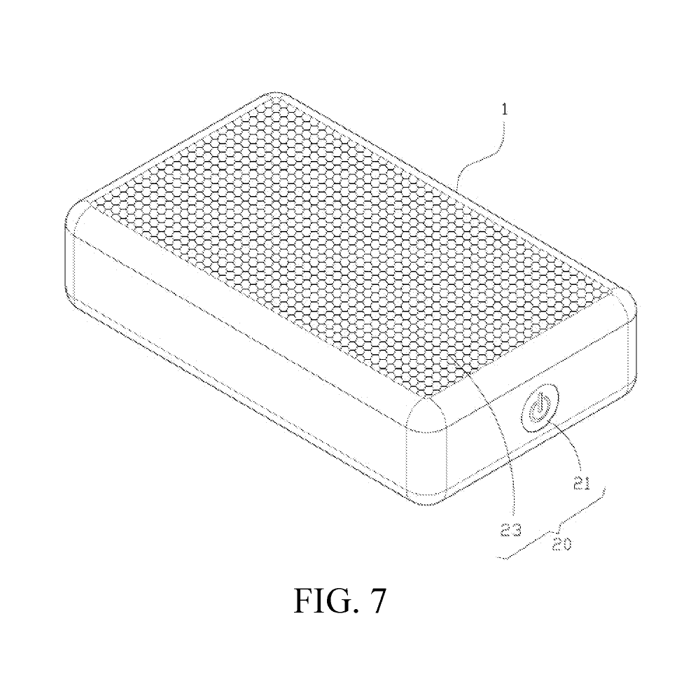

FIG. 7 is a schematic stereoscopic diagram of another embodiment of an audio output interface of a wireless earphone charging cradle. In some other embodiments, the audio output interface 20 includes a trigger input device 21 and a speaker 23. The audio output interface 20 generates the triggering signal TRI by pressing the trigger input device 21. The trigger input device 21 is electrically connected to the microprocessor 30. When being pressed, the input device 21 generates the sensing signal SEN to the microprocessor 30, and the microprocessor 30 causes the wireless earphone 200 to be electrically connected to the speaker 23, and the audio signal AUD received by the wireless transceiver 210 is output to the speaker 23 for playing. Regarding this, the wireless earphone charging cradle 1 can be used as a Bluetooth speaker.

In the foregoing embodiments, the wireless earphone charging cradle 1 can apply a wireless receiving and transmitting function of the wireless earphone 200, and an antenna or another wireless receiving and transmitting component does not need to be additionally set in the charging cradle, so as to save costs and simplify design, and to achieve an effect of providing audio source output while charging the wireless earphone 200.

Although this application has been disclosed above in the embodiments, they are not intended to limit this application. A person of ordinary skill in the art can make various variations and modifications to this application without departing from the spirit and scope of this application. Therefore, the protection scope of this application is subject to the appended claims.

What is claimed is:

1. A wireless earphone charging cradle for charging a wireless earphone comprising a wireless transceiver, wherein the wireless earphone charging cradle comprises:
a charging module configured to charge the wireless earphone when electrically connected to the wireless earphone;
an audio output interface configured to generate and send a sensing signal when the audio output interface is triggered; and
a microprocessor configured to be electrically connected to the charging module and the audio output interface respectively,
wherein the microprocessor is configured to generate a connection signal when receiving the sensing signal and transmits the connection signal to the wireless earphone by way of the charging module, so that the wireless earphone is electrically connected to the audio output interface, and an audio signal received by the wireless transceiver is transmitted to the audio output interface for output.

2. The wireless earphone charging cradle according to claim 1, further comprising:
a first electric connector,
wherein the wireless earphone comprises a second electric connector,
wherein the first electric connector is electrically connected to the audio output interface, and
wherein, when the charging module is electrically connected to the wireless earphone, the first electric connector is electrically connected to the second electric connector, so that the charging module charges the wireless earphone.

3. The wireless earphone charging cradle according to claim 2, wherein the wireless earphone comprises a third electric connector electrically connected to an electroacoustic transducer of the wireless earphone, when the microprocessor generates the connection signal and sends the connection signal to the wireless earphone, the wireless earphone disconnects the electric connection between the third electric connector and the electroacoustic transducer and the third electric connector is electrically connected to the second electric connector, and the audio output interface outputs the audio signal received by the wireless transceiver.

4. The wireless earphone charging cradle according to claim 2, wherein the charging module further comprises:
a battery; and
a charging circuit,
wherein, when the first electric connector is electrically connected to the second electric connector, the battery charges the wireless earphone by way of the charging circuit, the first electric connector, and the second electric connector.

5. The wireless earphone charging cradle according to claim 4, wherein the charging module comprises:
a transformer; and
a second charging circuit connected to the transformer,
wherein, when the transformer is connected to a power supply, the microprocessor causes the transformer to be electrically connected to the charging circuit, the battery is connected to the second charging circuit, and an electric power is provided by the power supply and transformed by the transformer for charging the wireless earphone by way of the charging circuit, the first electric connector, and the second electric connector and charging the battery by way of the second charging circuit.

6. The wireless earphone charging cradle according to claim 1, further comprising an amplifier electrically connected to the audio output interface,
wherein, when the microprocessor generates the connection signal and sends the connection signal to the wireless earphone, the amplifier is electrically connected to the wireless earphone, and the audio signal received by the wireless transceiver is amplified by the amplifier and is output by the audio output interface.

7. The wireless earphone charging cradle according to claim 1, wherein the audio output interface is a 3.5 mm audio port, a USB port, a mini USB port, a micro USB port, or a lightning port.

8. The wireless earphone charging cradle according to claim 7, wherein the audio output interface is triggered by an insertion of an audio playing apparatus, when the wireless earphone is electrically connected to the audio output interface, the audio signal received by the wireless transceiver is output to the audio playing apparatus by using the audio output interface for playing.

9. The wireless earphone charging cradle according to claim 1, wherein the wireless earphone charging cradle further comprises a pulse modulation unit, and the pulse modulation unit is electrically connected to the microprocessor and modulates the connection signal sent by the microprocessor in a pulse waveform.

10. The wireless earphone charging cradle according to claim 1, wherein the audio output interface comprises a trigger input device and a speaker, the audio output interface is triggered by pressing the trigger input device, the trigger input device is electrically connected to the microprocessor, when being pressed, the trigger input device generates the sensing signal and sends the sensing signal to the microprocessor, the microprocessor causes the wireless earphone to be electrically connected to the speaker, and the audio signal received by the wireless transceiver is output to the speaker for playing.

11. A wireless charging system, comprising:
a wireless earphone; and
a wireless earphone charging cradle for charging the wireless earphone, the wireless earphone charging cradle comprising:
a charging module configured to charge the wireless earphone when electrically connected to the wireless earphone;
an audio output interface configured to generate and send a sensing signal when the audio output interface is triggered;
a microprocessor configured to be electrically connected to the charging module and the audio output interface respectively; and
a first electric connector,
wherein the wireless earphone comprises:
a wireless transceiver;
an electroacoustic transducer;
a second electric connector; and
a third electric connector electrically connected to the electroacoustic transducer,
wherein the microprocessor is configured to generate a connection signal when receiving the sensing signal and transmits the connection signal to the wireless earphone by way of the charging module, so that the wireless earphone is electrically connected to the audio output interface, and an audio signal received by the wireless transceiver is transmitted to the audio output interface for output,
wherein the first electric connector is electrically connected to the audio output interface, wherein, when the charging module is electrically connected to the wireless earphone, the first electric connector is electrically connected to the second electric connector, so that the charging module charges the wireless earphone, and
wherein when the microprocessor generates the connection signal and sends the connection signal to the wireless earphone, the wireless earphone disconnects the electric connection between the third electric connector and the electroacoustic transducer and the third electric connector is electrically connected to the second electric connector, and the audio output interface outputs the audio signal received by the wireless transceiver.
